(19) United States
(12) Patent Application Publication
(10) Pub. No.: US 2005/0136961 A1
(43) Pub. Date: Jun. 23, 2005

(54) Power control method

(75) Inventors: Arne Simonsson, Gammelstad (SE); Jonas Pettersson, Lulea (SE); Marten Ericson, Lulea (SE); Niclas Wiberg, Linkoping (SE); Fredrik Gunnarsson, Linkoping (SE)

Correspondence Address: NIXON & VANDERHYE, PC, 1100 N GLEBE ROAD, 8TH FLOOR, ARLINGTON, VA, 22201-4714, US

(73) Assignee: Telefonaktiebolaget LM Ericsson (publ),, Stockholm (SE)

(21) Appl. No.: 10/736,898

(22) Filed: Dec. 17, 2003

(51) Int. Cl. H04B 7/00

(52) U.S. Cl. 455/522

(57) ABSTRACT

A method for downlink power control in wireless communication systems is provided. In response to a transmitter power change request from a mobile terminal (110) over a wireless connection, a power control parameter is determined at network level based on connection-specific information indicating the degree of priority of the connection (DPIᵢ). The power control parameter preferably relates to a maximum connection-specific transmitter power, a power step size and/or a quality target, and is used by the base station to distribute transmitter power (pᵢ) to the connection.

### TECHNICAL FIELD

The present invention relates to downlink power control in wireless communication systems, such as Wideband Code Division Multiple Access (WCDMA) systems.

### BACKGROUND

The main resource in a WCDMA downlink is the carrier power of the base station. The maximum carrier power limits the number of users that can be served, the service quality as well as the coverage of the base station. Each connection needs sufficient dedicated channel power to meet its associated quality requirement in terms of block error rate and thus provide acceptable perceived quality of service to the end user. Nevertheless, it is also important to utilize the power efficiently and not use more power than necessary, and therefore the transmitter power in the base station is regularly updated.

In WCDMA, fast power control is standardized for both up- and downlink [1]. The user equipment (UE) sends transmitter power control (TPC) commands, i.e. ‘power up’ or ‘power down’ indications, to the network. These commands are used in the base station to update the dedicated power of the UE. The default algorithm is to step-wise update the power, using the TPC command to define whether the new power value is to be the previous power value plus or minus a fixed power step size. Provided that saturation does not occur, the power control command is always granted. There are two options associated with the default power control algorithm, the first of which reduces the risk of misinterpreted TPC commands, and the second limits the power raise of the power control through a sliding window size and a threshold.

The standardized power control algorithms in 3GPP are primarily designed for situations when it is possible to fulfil all service requirements and the mutual interference can be compensated for. However, since the radio environment is time varying, situations may arise where there is not sufficient carrier power in the base station to fulfil the service requirements of all users and there is a risk for unstable system behavior 121. Wireless communication systems are generally provided with means for admission control and means for disconnecting services, but these are relatively slow and not designed for handling system instabilities. Therefore, there is a need for mechanisms that are able to handle this on a small time scale with fast actions.

Several alternative power control algorithms have been proposed. In [3], for example, a quality target is gradually reduced when the dedicated channel power is increased. Essentially, this means that users requiring high powers have to put up with lower quality.

The international patent application [4]addresses the problem of diverging transmitter output power levels of two or more base stations with respect to a mobile station in macro-diversity communication. The respective base station transmitter output powers for the mobile station are adjusted in response to the power control instructions from the mobile station and the respective current base station transmitter output powers for the mobile station. The adjustments can be performed in fixed or continuous steps.

Step size adjustments based on TPC history, mobility speed and bit error rate (BER) probability is e.g. described in documents [5], [6] and [7].

Although the above solutions have resulted in better downlink power control mechanisms they are still associated with problems. A drawback of prior art power control is for example that insufficient power resources result in that all connections are “punished”, which makes the situation rather unpredictable for individual mobiles. There is also a considerable risk of overallocating and temporary running out of transmitter power.

Accordingly, there is a need for an improved downlink power control method.

### SUMMARY

A general object of the present invention is to provide a method for downlink power control that improves the stability of wireless communication systems. A specific object is to achieve a more sophisticated utilization of power resources in communication systems with shared resources. Another object is to provide a power control mechanism suitable for WCDMA systems.

These objects are achieved in accordance with the attached claims.

With prior-art solutions for power control, limited power resources result in that all connections sharing a particular resource are punished, irrespective of their respective characteristics. Briefly, the present invention proposes a method where power instead is distributed to the respective connections depending on how important each connection is considered to be. In response to a transmitter power change request from a mobile terminal, a power control parameter, such as a maximum connection-specific transmitter power, a power step size or a power increase probability, is determined based on connection-specific information indicating the prioritization of the connection. This connection-specific information generally comprises a degree of priority indicator parameter, such as a subscriber class, a mobile type/class, a connection time, or a data service feature (e.g. packet type). The power control parameter is then used by the base station to distribute transmitter power to the connection. By prioritizing different connections differently a “fair” power distribution can be achieved. Power restrictions can for example be imposed on connections that are considered to be especially troublesome, whereby the system stability will be improved.

In some advantageous embodiments of the invention, power, control is performed based on connection-specific information indicating the degree of priority associated with the connection together with the current total transmitter power and/or the connection-specific code power.

According to other aspects of the invention, a transceiver node, a control unit, and a communication system are provided.

### BRIEF DESCRIPTION OF THE DRAWINGS

The invention, together with further objects and advantages thereof, is best understood by reference to the following description and the accompanying drawings, in which:

FIG. 1 is a schematic overview of an exemplary WCDMA communication system in which the present invention can be used;

FIG. 2 illustrates downlink power control messaging in accordance with the present invention; and

FIG. 3 is a flow chart of a method for downlink power control according to a preferred embodiment of the present invention.

### DETAILED DESCRIPTION

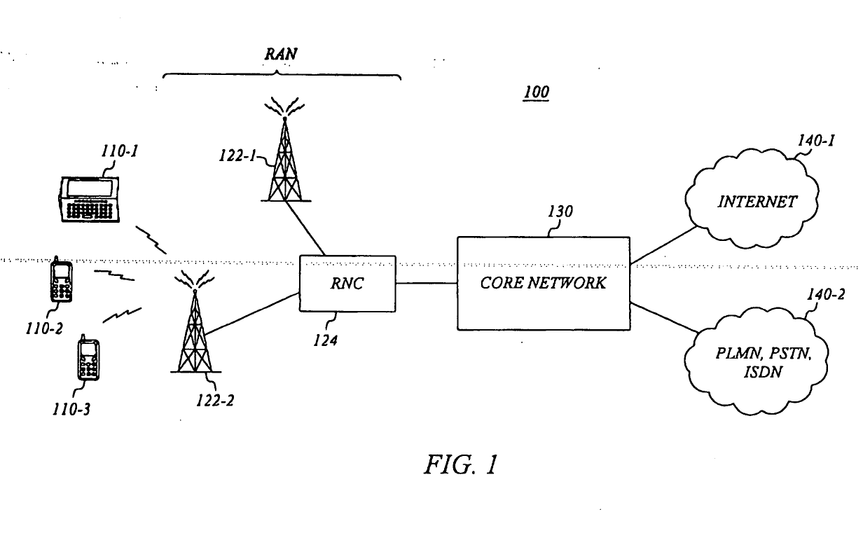

FIG. 1 is a schematic overview of an exemplary WCDMA communication system in which the present invention can be used. The illustrated system 100 comprises a Radio Access Network (RAN), e.g. a Universal Terrestrial Radio Access Network (UTRAN), and a core network 130. The RAN performs radio-related functions and is responsible for establishing connections between user equipment 110, such as mobile phones and laptops, and the rest of the network. The RAN typically contains a large number of Base Transceiver Stations (BTS) 122, also referred to as Node B, and Radio Network Controllers (RNC) 124. Each BTS serves the mobile terminals within its respective coverage area and several BTS are controlled by a RNC. Typical functions of the RNC are to assign frequencies, spreading or scrambling codes and channel power levels.

The RNC 124 provides access to the core network 130, which e.g. comprises switching centers, support nodes and databases corresponding to those of a Global System for Mobile communication/General Packet Radio Service (GSM/GPRS) core network, and generally also includes multimedia processing equipment. The core network communicates with external networks 140, such as the Internet, and Public Switched Telephone Networks (PSTN), Integrated Services Digital Networks (ISDN) and other Public Land Mobile Networks (PLMN).

In practice, most WCDMA networks present multiple network elements and nodes arranged in much more complex ways than in the basic example of FIG. 1.

The present invention is well suited for and will primarily be described in connection with WCDMA communication, for example High-speed Downlink Shared Channel (HS-DSCH) systems. Nevertheless, it should be understood that other communication systems where multiple users can utilize the same power resource simultaneously also lie within the scope of the invention. Systems where the power utilization of a node affects adjacent nodes due to high interference are also suited for the invention. Such systems for instance include time-multiplexed or code-multiplexed Orthogonal Frequency Division Multiplexing (OFDM) and Time Division Multiple Access (TDMA) systems and systems using Multi Carrier Power Amplifiers (MCPA).

Effective mechanisms for uplink and downlink power control are essential for maximizing the capacity of wireless communication systems like CDMA systems. Power control for the downlink (forward) channel in particular serves to provide each mobile station with a satisfactory signal level from the base station. Typically, the mobile station measures the received signal on the downlink channel and based on the measurements requests the base station to adjust its transmit power.

As mentioned in the background section, fast power control (1500 Hz) is in WCDMA standardized for both up- and downlink. The UE sends a transmitter power control command TPC(t) to the network 1500 times per second, and each command states either ‘power up’ or ‘power down’. This command is used in the base station to update the dedicated power of the UE p(t). The 3GPP standardized downlink power control algorithms include one default algorithm with two options [1]. The default algorithm is to step-wise update the power p(t) in logarithmic scale (in dB) every slot t, using the received transmitter power control command TPC(t), which is either +1 or −1 according to:
p(t+1)=p(t)+Δ* TPC(t) [dB] (1)
where Δ is the step size in dB. The step size Δ can have four values: 0.5, 1, 1.5 or 2 dB. It is mandatory for UTRAN to support a step size of 1 dB, while support of other step sizes is optional. The only reason for not granting the power control command is if the power saturates, i.e. the power meets the upper or lower limitations (p_upper and p_lower respectively), which are parameterized by the operator. This implies that
p(t+1)=max(p_{—}lower, min(p_{—}upper, p(t)+Δ*TPC(t))) [dB] (2)

The first option aims at limiting the risk of misinterpreted TPC commands. Each TPC command is repeated three consecutive slots, and the actual update rate is thereby reduced to 500 Hz. The second option limits the power raise of power control by defining a sliding window size Swim and a threshold th. The power is only allowed to increase if the sum of past Swim corrections is below the threshold th:

$$p ( t + 1 ) = \{ \begin{matrix}p ( t ) - Δ & if TPC ( t ) = - 1 \\ p ( t ) + Δ & if TPC ( t ) = 1 , TPC sum < th \\ p ( t ) & if TPC ( t ) = 1 , TPCsum \geq th\end{matrix} \qquad ( 3 )$$

where TPCsum is the sum of past corrections, i.e.

$$TPCsum = {\sum }_{k = t - Swin + 1}^{i} TPC ( k )$$

For data services, the total amount of data is divided into packets in higher layers, e.g. IP packets in case of file transfer, web browsing, etc A typical IP packet size is 1500 bytes. In the medium access layer, these larger packets are segmented into smaller entities, “transport blocks”, which are sent over the radio interface in one or several radio frames. These blocks may be provided with cyclic redundancy check (CRC) codes so that the receiver side can detect block errors. The block error rate (BLER) of a radio link is an important quality of service indicator, and in UTRAN, for example, it is possible to specify an optional parameter quality target comprising a desired block error rate for each dedicated radio link. If such a quality target is specified, the downlink power control is normally performed such that the mobile terminal sends power control commands to meet this quality target.

The present invention is based on the recognition that an improved power control mechanism and thus an improved system stability can be achieved through making distinctions between individual connections based on their respective characteristics and, when deemed appropriate, treat different connections differently. The main idea is to avoid a situation where all connections experience unsatisfactory quality of service by adopting a proactive strategy to penalize some connections to save others. One ambition can for example be to try to penalize the connections that are causing the problems. Another is to favor connections that are considered as especially important.

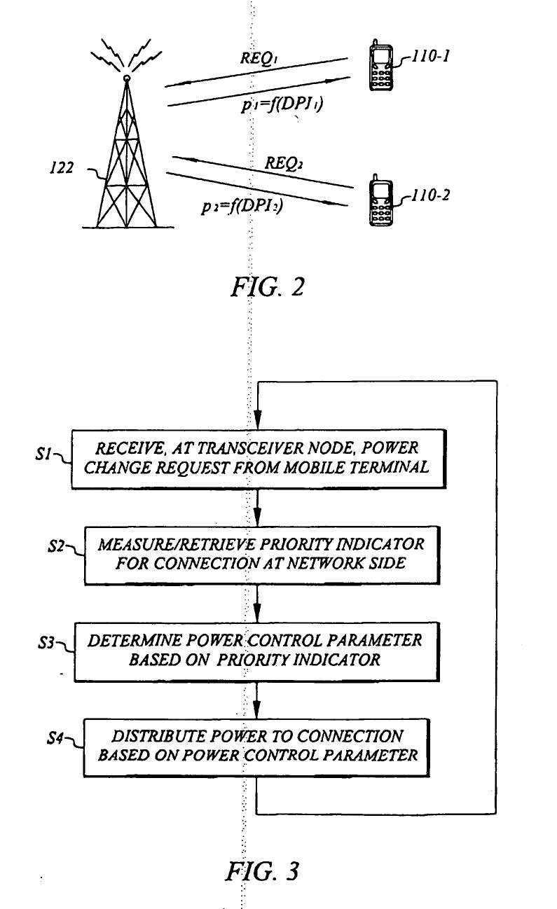

The present invention proposes an approach where the downlink power control is based on the degree of priority associated with the respective connections. This will now be further described with reference to FIG. 2, in which a transceiver node 122 and two mobile terminals 110 are shown. The transceiver node is capable of communicating with the mobile terminals over respective wireless connections.

The transceiver node 122 is typically arranged at the network side, e.g. in a radio access network such as UTRAN, and enables wireless units to be connected to the rest of the network. The transceiver node can for instance comprise or be associated with a (radio) base station such as a Node B or a BTS and/or radio control functionality such as an RNC or a Base Station Controller (BSC). In the following, the transceiver node will generally be referred to as base station.

The wireless units/mobile terminals 110 (also referred to as user equipment, mobile nodes, mobile stations, etc) are illustrated as cellular phones. However, the invention is also applicable on communication with other wireless unit, including personal digital assistants and laptop computers.

As indicated in FIG. 2, each connection i has a respective dedicated transmitter (downlink) power pᵢ, also referred to as the downlink code power of the connection. The current connection-specific transmitter power pᵢ (t) represents the downlink power allocated to connection i by the base station at a particular point of time t. By default, the code power allocation is performed according to the power control algorithm of Eq. (1), but according to the present invention this power allocation is handled in an improved way that will now be described.

The wireless unit 110 sends a request for a power change (e.g. a power increase command) to the base station 122. As opposed to with the above-described default power control algorithm, the request is not always granted.

Based on the (current) priority level of the connection, it is decided whether an individual request should be granted or wholly or partially refused. The connection-specific power decision is expressed through one or several power control parameters, which preferably directly or indirectly relate to a maximum value or a power change rate of the connection-specific transmitter power. The power control parameters are determined based on connection-specific information indicating the degree of priority associated with the connection, and thereafter used to distribute transmitter power to the particular connection. The connection-specific information preferably comprises one or more so-called degree of priority indicators DPI. Hence, the power pᵢ dedicated to connection i depends on the DPI parameter for the connection DPIᵢ. Example DPI parameters are described in the section “Priority indicators”.

FIG. 3 is a flow chart of a method for downlink power control summarizing the main principles of a preferred embodiment of the invention. In step S1, a transmitter power change request from a mobile terminal is received at a base station over a wireless connection. This request can for example comprise a standard WCDMA TPC command and the invention is applicable to both increase and decrease commands. In particular, it is useful for handling situations with repeated power increase commands.

In response to the transmitter power change request, a network-based node, such as a base station or a RNC, determines at least one power control parameter based on the degree of priority indicator in step S3. This can e.g. involve executing a predetermined power distribution function, or deciding the power control parameter based on a predetermined threshold value for the DPI parameter. The power control parameter is preferably related to a maximum connection-specific transmitter power and/or the power change rate of the connection-specific transmitter power. The priority indicating parameter is typically measured or collected from data holding units such as databases at the network side (step S2), preferably by means of a network-based control unit, such as an RNC (124 in FIG. 1). As will be explained in the following, the power control parameter can e.g. be an aggregate power control parameter calculated by combining several separately computed power control parameters with different inputs. The input parameters may include different DPI parameters as well as other parameters.

Finally, transmitter power is in step S4 distributed to the connection by the base station in accordance with the determined power control parameter.

The power control parameter can be directly or indirectly affecting the actual power distribution. An example of the latter is to indirectly restrict the power (p(t) in Eq. (1)) through a power control parameter related to the highest bit rate allowed for the connection. The procedure in FIG. 3 is typically repeated regularly during an ongoing connection, since the mobile terminal will repeatedly ask for more or less power as the conditions change.

By means of the power control method of the present invention, it is possible to distinguish between different connections in the power control. The power distribution can be restricted in accordance with appropriate prioritization concerns, which enables a more fair power distribution. Furthermore, the power control of invention results in an improved system stability, generally on a long term basis, which in turn leads to an enhancement of both the capacity and the quality of the services experienced by the users.

Priority Indicators

The parameters indicating the degree of priority of a wireless connection used in accordance with the invention can include parameters measured or stored at the network side as well as parameters transferred to the network from the mobile terminal. The DPI parameter is representing the importance/relevance/priority of a particular connection at a particular point of time in a predefined way. It generally describes features or the current or expected behavior of the end user/mobile terminal and can comprise user-related, device-related and/or connection-descriptive information. Both constant (or rarely changing) value parameters and current and/or previous values of parameters that are changing over time can be used.

Mobile Type and Class

Some types of mobile terminals can be worse than others to utilize the downlink power, in the sense that they require more power from the base station when providing the same service in the same radio environment. A terminal with inferior receiver performance often uses a comparatively large portion of the power resource with only a minor service usage. From a system perspective, it can hence be desirable to provide a different user perceived quality of service to different types of mobiles. The type of mobile terminal can be used as priority indicator in the power control according to the invention. In accordance with some embodiments of the invention, the brand or model of the mobile terminal is used as priority indicator, e.g. enabling different models to be differently prioritized in the power control.

However, despite test cases and specifications from standardization bodies, the UE receiver performance may vary considerably between different UE vendors and the required downlink power for a specific service in a specific environment can vary. Information about the model of the mobile terminal is not always enough for interpreting the performance of the mobile and thus its prioritization correctly or sufficiently precise. Therefore, a preferred embodiment of the invention suggests that the classification of mobiles is automatized. Instead of relying on indirect information like mobile brand and model, the actual performance or power requirement of the mobile terminal is determined at the network side and based thereon the terminal is automatically classified.

The proposed procedure may e.g. result in that the terminal is classified as “good” or “bad”, respectively, or according to a linear or other scale. The mobile terminals could for example be classified based on required downlink code power when connected to a specific reference cell; IMIE number; and or block error rate (for data services). The automatic classification can either be based on measured connection-related information or on stored connection-related information, e.g. retrieved from one or more databases residing at the node performing the classification (e.g. RNC) or being distributed in the network. A preferred embodiment of the invention performs adaptive classification of mobile terminals based on information from ongoing calls. The measured information can e.g. comprise data service features, such as block error statistics and block retransmission statistics.

Other information can also be used for automatically classifying mobiles in accordance with the present invention, including connection-specific parameters described herein, e.g. in the subsection “Data service features”.

Subscription Class

When it is desirable to prioritize one or a number of subscription classes in front of others, the subscription class sᵢ is an important input. In such embodiments, there can be two or more priority levels and each subscription class is assigned a respective priority level. Prioritization based on subscriber class enables for operators to offer gold subscriptions with better services to customers that pay more.

Connection Time

The longer the mobile terminal has been connected, the more critical it is to penalize the connection. Therefore, the time since connection establishment t_{c} is an informative input. Power control based on the time of a connection/data session is generally performed such that a longer connection is prioritized.

The connection time can be measured at the base station but hand-over procedures normally results in that such information can be lost. Therefore, it is generally preferred to determine/measure the connection time at a network-based control unit, such as RNC.

Data Service Features

For data services it can often be appropriate to use the current values of certain data service features as a basis for the prioritization between different connections in accordance with the invention. The data service features e.g. provide information about the current and expected user behavior.

The data service features would typically be measured at the network side, preferably at the RNC or a corresponding node, to obtain a prioritization measure for a specific (ongoing) connection. Example data service features include indicators related to the transmitted data amount, the expected data amount, and/or the data amount residing in buffers before being transmitted. Hereby, a larger amount of data generally implies a higher degree of priority associated with the connection.

Power control clearly affects the block error rate of the connection. Furthermore, the impact of the block errors typically depends on how the radio link control layer is configured. If the connection uses an acknowledged mode, erroneous blocks are identified by the mobile terminal, and this is signaled to the connected node (e.g. RNC or Node B) so that these blocks can be retransmitted. Since blocks combine to packets, and transport control protocols are sensitive to packet delays, it can be relevant to prioritize connections differently, depending on the position in the packet of the block. With information about the type of packet (RTP, TCP, header information), this can e.g. be used to determine how sensitive the transport control layer and application layer are to lost blocks. Very active connections suffer more from lost blocks, since the transport layer quickly reduces the data rate on indications of lost or delayed packets, whereas low-active connections will not suffer as much.

The block error rate of a specific connection is related to factors like power consumption, radio propagation characteristics, UE velocity, and UE receiver performance. For dedicated links, inner and outer loop power control aims at a predefined block error rate (quality target). For HS-DSCH, the situation is different. The UE measures the quality of the pilot power, uses a signaled parameter γ reflecting the approximate difference between the pilot power and the power available for HS-DSCH. This is used in the UE to compute the highest possible data rate (provided by one of several predefined transport formats) and this is coded and signaled to the connected Node B. Since the actual level of available HS-DSCH power varies quickly, Node B needs to recompute what transport format the UE actually can receive, given the difference between the actual HS-DSCH power level, signaled difference y to the UE, and the reported transport format from the UE.

UE:s with inferior quality estimation could tend to overestimate the quality, or users with a high estimation error variance tend to be selected for transmission more often (in order to maximize Node B throughput), but this will result in many erroneously received blocks, which is misuse of resources. The block error rate is an indication of how well the UE:s estimate the pilot quality and the receivable transport formats, and therefore it can be relevant to use a lower than available HS-DSCH power for such users when computing what transport formats they can support.

Accordingly, in a packet-based communication system, the power distribution can with advantage be based on one or more DPI related to packet features, such as packet length, packet type, and/or time since last packet. Packet length indicators, for example, will generally be used such that connections with longer packets will be prioritized, since the risk of delays due to lost packets will be higher for such connections. Moreover, the connection-specific information used as priority indicator in some embodiments relates to data service features comprising block error statistics and/or block retransmission statistics for the connection.

Some preferred ways of imposing power restrictions according to the invention involve adapting the maximum dedicated code power pᵢₘₐₓ; adapting the power step size Δᵢ, and/or stating a probability πᵢ of granting a power change request command. Exemplary embodiments of the invention with power control by means of each of these power control parameters will now be described. The exemplifying power control algorithms work for values both in linear (WI and logarithmic scale [dBW or dBm], but values in linear scale will be assumed if nothing else is stated.

Maximum Dedicated Code Power

A preferred means to reduce the possibility of a connection to contribute to the downlink carrier power is to decrease the maximum dedicated code power p_{i, max}, i.e. the upper power limit of an individual dedicated channel. The computed maximum dedicated code power can be seen as a function of the priority indicating parameter DPI: p_{i, amx}=f(DPIᵢ).

Connection Time

It can be more critical to penalize connections with long connection times. Furthermore, there is considerable risk associated with admitting a user, who already initially requires close to maximum downlink code power. It is better to use a lower maximum downlink code power initially, and gradually increase this limitation. The shorter the connection time, the lower the maximum downlink code power.

In a first example (4), the maximum dedicated code power varies from p_{max, lower} to p_{max, upper,} and depends linearly on the connection time up to tₗᵢₘ. For t_{c} greater than tₗᵢₘ, p_{max,i} =p_{max, upper}
pₘₐₓ,i=p_{max,upper}+(p_{max, upper}−p_{max, lower})* (t_{c}−tₗᵢₘ)/tₗᵢₘ (4)

A second example (5) presents a simpler method with two different values of the maximum dedicated code power depending of whether the connection time is less than tarn or not.

$${p}_{max , i} = \{ \begin{matrix}{p}_{max , upper} & {t}_{c} > {t}_{lim} \\ {p}_{max , lower} & {t}_{c} \leq {t}_{lim}\end{matrix} \qquad ( 5 )$$

Subscription Class

It can sometimes be desirable to prioritize some users. A prioritized user could be allowed to consume more resources to reduce the risk of disconnecting the connection. In an exemplary embodiment (6) there are two priority levels. The value of the maximum dedicated code power depends on whether the subscription class Sᵢ is prioritized or not.

$${p}_{max , i} = \{ \begin{matrix}{p}_{max , upper} & {s}_{i} prioritised \\ {p}_{max , lower} & {s}_{i} not prioritised\end{matrix} \qquad ( 6 )$$

Mobile Type

Specific types of mobile terminals, e.g. identified through their respective brand or model, can be identified as less sensitive or associated with lower performance than others. In order to avoid that these mobiles consume too much of the resources relative to the service provided, it can be appropriate to differentiate the downlink code power between terminals associated with different degrees of performance. This is illustrated by the below example (7), according to which the value of the maximum dedicated code power depends on whether the mobile is identified as low-performing or not.

$${p}_{max , i} = \{ \begin{matrix}{p}_{max , upper} & acceptable mobile \\ {p}_{max , lower} & low \text{-} performing mobile\end{matrix} \qquad ( 7 )$$

This could be used for obtaining substantially the same power consumption for each mobile brand and model over a long period of time. In some embodiments, downlink code power statistics is collected for each mobile brand and model, whereafter a lower maximum code power is assigned to mobile terminals which consume more power than an average terminal, and vice versa, assuming that the radio environment is similar for all mobiles over a long period of time. As described previously, a mobile class parameter can also be automatically determined based on the current performance of a particular mobile terminal.

It should be noted that a DPI parameter may be used together with one or more other input parameters (DPI or other) for determining the maximum downlink code power. When more than one input are used, each input can be used to compute the maximum power, and the aggregate of these computed values is used as the maximum dedicated code power. In an exemplifying embodiment with two different inputs, the aggregate is computed according to (6).
p_{i, max, aggregate}=min(p_{i, max, input 1}, p_{i, max, input 2}) (6)

The above examples have used actual (not normalized) power parameters. However, in some situations, for example when different connections have different maximum downlink code power, it can be relevant to consider the downlink code power relative maximum code power as input.

Power Control Step Size

In the default power control algorithm in WCDMA, the base station increases the dedicated channel power by a fixed step Δ in dB, when receiving a power up TPC command from the mobile terminal. Only the maximum dedicated code power can hinder the power increase.

The present invention instead proposes to adapt the power control step Δ in response to the degree of priority associated with the respective connection: Δᵢ=f(DPIᵢ). The size of the power change (upward or downward) may be either decreased or increased. A power increase request from the mobile terminal may even result in zero or negative values of Δ, thus corresponding to a refused increase command. It can sometimes be preferred to limit the step size adaptation to upward steps, which are more critical for downlink stability, while letting the downward steps remain constant.

Sometimes, e.g. if it is not possible to adjust the step size directly, it may be advisable to adjust the power only each N:th slot, where N floor(Δₙₒᵣₘ/Δ_{desired}) and Δnorm is a possible adjustment step (e.g. 1 dB).

Connection Time

It can be considered more important to provide extra support to calls with long connection times. A short connection time implies a small (upward) step size, and vice versa. According to example (7) the (upward) step size is selected according to whether the connection time is below or above a threshold tₗᵢₘ.

$${Δ}_{i} = \{ \begin{matrix}{Δ}_{upper} & {t}_{c} > {t}_{lim} \\ {Δ}_{lower} & {t}_{c} \leq {t}_{lim}\end{matrix} \qquad ( 7 )$$

Subscription Class

In the below example (8), the value of the (upward) step size depends on whether the subscription class sᵢ is prioritized or not. A prioritized user is allowed to consume more resources to reduce the risk of disconnecting the connection and here this is expressed through allowing larger power increases for such a user.

$${Δ}_{i} = \{ \begin{matrix}{Δ}_{upper} & {s}_{i} prioritised \\ {Δ}_{lower} & {s}_{i} not prioritised\end{matrix} \qquad ( 8 )$$

Mobile Type

In order to avoid that low-performing mobiles consume too much of the resources compared to the service provided, it can be desirable to differentiate the (uplink) step size normal mobiles and low-performing mobiles. An exemplifying embodiment is provided in Eq. (9) The value of the (upward) step size depends on whether the mobile is identified as low-performing or not.

$${Δ}_{i} = \{ \begin{matrix}{Δ}_{upper} & acceptable mobile \\ {Δ}_{lower} & low \text{-} performing mobile\end{matrix} \qquad ( 9 )$$

More than one input can be used to determine the step size. Hereby, each input can be used to calculate a respective step size, and the aggregate of these preliminary step size values is used as the step size through which the power control is effectuated. In an exemplify embodiment with two different inputs (at least one DPI), the aggregate is computed according to (10).
Δ_{i, aggregate}=min(Δ_{l, iput 1, Δi, input 2}) (10)
Power Increase Probability

In the default power control algorithm in WCDMA, the base station increases the dedicated channel power by a step Δ upon receiving a transmitter power up command from the wireless unit. Only the maximum dedicated code power pin=can hinder the power increase from being granted. According to this embodiment of the invention, grant of a received power up command is instead associated with an assigned probability π_{inc, i} (possibly zero), referred to as a power increase probability. If a power up request is not granted there are two options. Either the connection-specific transmitter power pᵢ(t) remains at the same level, or it is decreased by the step Δ. The latter is more efficient in penalizing a connection.

In this case, it can be very beneficial to use combinations of priority indicators and load inputs (see below). Thereby, the priority indicators are used to limit the set of mobiles effected by load-based power increase probability changes. Furthermore, according to some exemplary embodiments a power increase probability less than 1 is only applied to non-prioritized subscribers, to identified low-performing mobiles, and/or to connections with connection times less than tₗᵢₘ.

When more than one input is used, each input can be used to compute the power increase probability, and the aggregate of these computed values is used as the power increase probability. In an example with two different inputs (at least one being a DPI), the aggregate is computed according to (11).
π_{inc, i, aggregate}=π_{inc, i, input 1}*π_{inc, i, input 2} (11)

Indirect Dower control Parameters

The power control of the invention can thus with advantage be performed using the above-described power control parameters p_{i, max}, π_{inc, i,} and Δᵢ. Hereby, one single control parameter or, alternatively, a combination of two or all control parameters can be used for a particular power control situation. There may also be embodiments of the invention where the power control is effectuated through other power-related parameters, including other parameters directly or indirectly related to a power change rate of the connection-specific transmitter power.

By imposing restrictions on the highest bit rate that is allowed for a connection, the power dedicated to the connection will also be restricted due to the close relation between power and bit rate in CDMA and similar systems. In this case, the power control parameter is thus indirectly affecting the power allocation by affecting another power control parameter upon which the power control depends more directly.

Quality Target

In connection with data services, a quality target of the connection can be used as power control parameter, instead of or in addition to the above-described power control parameters. In this embodiment of the invention, the connection-specific priority indicating information is thus used to determine a quality target parameter, rather than the code power directly. The quality target can for instance define the desired quality of a connection, such as the BLER quality target used in WCDMA. The BLER target is the ratio between the number of erroneous blocks and the total number of transmitted blocks. The quality target affects the power allocation via the power control commands sent from the mobile terminal. One exemplifying embodiment illustrated by Eq. (12) is to assign two different BLER targets depending on mobile performance.

$$BLER {target}_{i} = \{ \begin{matrix}BLER {target}_{lower} & acceptable mobile \\ BLER {target}_{upper} & low \text{-} performing mobile\end{matrix} \qquad ( 12 )$$

Load-Based Dower Control

According to a preferred embodiment of the invention, a most efficient downlink power control is obtained by changing the power dedicated to a respective connection in response to the total transmitter power situation in addition to the connection priority indicator. In order to enhance the system stability this embodiment proposes an overall control approach where downlink power control is based also on the total transmitter power (downlink carrier power) of the base station. Hence, the power pᵢ dedicated to connection i depends on the total downlink power P_{DL} and a DPI for the connection DPLIᵢ.

The total transmitter power P_{DL} comprises both common power (used e.g. for pushing information to end users, for pilot signals and for common/shared channels) and power for channels dedicated to specific mobile terminals. The current total transmitter power P_{DL}(t) represents all downlink power resources, common and connection-specific, used at the transceiver node at a particular point of time t. The available downlink power resources are represented by a maximum transmitter (downlink) power P_{DL, max}, which is transceiver node specific.

In response to the transmitter power change request, at least one power control parameter is in this embodiment determined based on the current total transmitter power of the base station and one or more DPI parameters. This preferably involves executing a predetermined power distribution function that presents a smooth transitional behavior as the current total transmitter power approaches its maximum value, or alternatively the power control parameter may be decided based on a predetermined threshold value for the total transmitter power. The total transmitter power of the base station is preferably continuously measured at the base station, but there may be embodiments where this parameter is determined elsewhere.

In this embodiment of the invention, the behavior of respective connections is adjusted depending on the behavior of the entire shared power resource. Thereby, an efficient power control mechanism is provided, which can be used to ensure that no attempts are made on the network side to allocate more power resources than available. The risk of temporary running out of transmitter power can thus be eliminated, resulting in preserved system stability and higher capacity. Moreover, a smooth response to power increase requests from the user equipment can be achieved. The allocated power can be made to rise smoothly when the maximum transmitter power is approached, which leads to a more controlled behavior of the base station transmitter power. The control is preferably performed on a comparatively small time scale, which results in fast adjustments as the overall power situation changes.

In another embodiment the power control parameter is determined by a combination of the connection-specific transmitter power (downlink code power) in addition to one or more DPI parameters. Connections using a lot of code power can for example be “punished” through stronger power restrictions.

According to a particularly advantageous embodiment, the power control parameter is determined by a combination of the total transmitter power of the base station and the connection-specific transmitter power in addition to one or more DPI parameters. This power control is both related to the connection-specific resource utilization and to the overall resource utilization of all links. Hereby, power saturation can be avoided and besides the smooth transitional behavior at high total transmitter powers (i.e. close to P_{DL, max}) it is also possible to make distinctions between different connections with regard to the current connection-specific load as well as on a more long term basis with regard to the priority level associated with the connection.

Since the input power data typically varies fast and heavily, it can in many cases be advisable to use filters in connection with the downlink power control functions. By considering current as well as previous values of the input parameters, the variance can with filtering be reduced such that the power control parameters are subject merely to slowly changing input data.

Although the invention has been described with reference to specific illustrated embodiments, it should be emphasized that it also covers equivalents to the disclosed features, as well as modifications and variants obvious to a man skilled in the art. Thus, the scope of the invention is only limited by the enclosed claims.

### REFERENCES

[1] 3GPP, Physical layer procedures (FDD), Technical Specification TS 25.214.
[2] Gunnarsson, F. and Gustafsson, F., Power Control with Time Delay Compensation, Proc. Vehicular Technology Conference, Boston, Mass., USA, September 2000.
[3] U.S. Pat. No. 5,574,982, M. Almgren, et. al.
[4] International Patent Application WO 02/35731 A1, Telefonaktie-bolaget L M Ericsson.
[5] International Patent Application WO 00/04649, Nokia Networks OY.
[6] European patent application EP 0 815 656 Bl, Nokia Corporation.
[7] U.S. Pat. No. 6,311,070 Bl, Wen Tong, Rui. R. Wang.

1. A method for power control in a communication system (100) including a transceiver node (122) capable of communicating with multiple mobile terminals (10), comprising the steps of
receiving, at the transceiver node, a transmitter power change request from one of the mobile terminals over a wireless connection;
determining a power control parameter for the connection at the network side based on connection-specific information indicating the degree of priority associated with the connection; and
distributing transmitter power to the connection in accordance with the power control parameter.

2. The method of claim 1, wherein determining step is based on a predefined relationship between the connection-specific information and the degree of priority.

3. The method of claim 1, wherein the connection-specific information comprises information selected from the group of: mobile type, mobile class, subscription class, and connection time.

4. The method of claim 1, further comprising the steps of:
automatically classifying the mobile terminal (110) at the network side based on connection-related information; and
using the mobile class from the classifying step in the determining step.

5. The method of claim 4, further comprising the step of measuring the connection-related information at the network side.

6. The method of claim 4, further comprising the step of collecting, at the network side, the connection-related information from a data holding unit.

7. The method of claim 1, wherein the communication system (100) is packet-based and the connection-specific information comprises information selected from the group of: transmitted data amount, data amount in buffer, packet length, packet type, time since last packet, block error statistics, and block retransmission statistics.

8. The method of claim 1, wherein the determining step is performed at a network-based control unit (124) and further comprising the step of transmitting control information comprising the power control parameter for the connection from the network-based control unit to the transceiver node (122).

9. The method of claim 1, further comprising the step of receiving, at the transceiver node (122), the connection-specific information from the network-based control unit (124), and wherein the determining step is performed at the transceiver node.

10. The method of claim 1, wherein the power control parameter is directly or indirectly related to a maximum value of the connection-specific transmitter power.

11. The method of claim 1, wherein the power control parameter is directly or indirectly related to a power change rate of the connection-specific transmitter power.

12. The method of claim 11, wherein the power control parameter comprises a power change step size.

13. The method of claim 1, wherein the power control parameter comprises a quality target parameter.

14. The method of claim 1, wherein the determining step involves executing a predetermined power distribution function selected from the group of: a step function, a stepwise function, and an at least partially continuous function.

15. The method of claim 1, comprising the further steps of
combining at least two power control parameters based on different input parameters into an aggregate power control parameter; and
using the aggregate power control parameter for distributing the power in the distributing step.

16. The method of claim 1, wherein the determining step is further based on a current total transmitter power of the transceiver node (122).

17. The method of claim 1, wherein determining step is further based on a current connection-specific transmitter power for the connection.

18. A transceiver node (122) capable of communicating with multiple mobile terminals (110) and including means for power control, comprising
means for receiving a transmitter power change request from one of the mobile terminals over a wireless connection; and
means for distributing transmitter power to the connection in accordance with a power control parameter for the connection, said power control parameter being based on connection-specific prioritization information.

19. The transceiver node of claim 18, comprising means for receiving control information comprising the power control parameter for the connection from the network-based control unit.

20. The transceiver node of claim 18, further comprising
means for determining the power control parameter for the connection based on connection-specific information indicating the degree of priority associated with the connection.

21. The transceiver node of claim 20, further comprising means for receiving the connection-specific information from a network-based control unit (124).

22. The transceiver node of claim 18, wherein the connection-specific information comprises information selected from the group of: mobile type, mobile class, subscription class, and connection time.

23. The transceiver node of claim 18, wherein the connection-specific information comprises a mobile class of the mobile terminal (110), automatically decided at the network side based on connection-related information.

24. The transceiver node of claim 18, wherein, for a packet-based communication system (100), the connection-specific information comprises information selected from the group of: transmitted data amount, data amount in buffer, packet length, packet type, time since last packet, block error statistics, and block retransmission statistics.

25. The transceiver node of claim 18, wherein the power control parameter is directly or indirectly related to a parameter selected from the group of: a maximum value of the connection-specific transmitter power, a power change step size, and a quality target parameter.

26. The transceiver node of claim 18, wherein the power control parameter is determined based also on a current total transmitter power of the transceiver node (122).

27. A network-based control unit (124) connected to a transceiver node (122) capable of communicating with multiple mobile terminals (110) over respective wireless connections and including means for power control, comprising
means for receiving, from the transceiver node, an indication of a transmitter power change request from one of the mobile terminals;
means for determining a power control parameter for the connection of the mobile terminal based on connection-specific information indicating the degree of priority associated with the connection; and
means for communicating the power control parameter to the transceiver node for power distribution purposes.

28. The control unit of claim 27, wherein the connection-specific information comprises information selected from the group of: mobile type, mobile class, subscription class, and connection time.

29. The control unit of claim 27, further comprising
means for measuring connection-related information; and
means for automatically classifying the mobile terminal (110) based on the connection-related information.

30. The control unit of claim 27, further comprising
means for collecting connection-related information from a data holding unit; and
means for automatically classifying the mobile terminal (110) based on the connection-related information.

31. The control unit of claim 27, wherein, for a packet-based communication system (100), the connection-specific information comprises information about an item selected from the group of: transmitted data amount, data amount in buffer, packet length, packet type, time since last packet, block error statistics, and block retransmission statistics.

32. The control unit of claim 27, wherein the power control parameter is directly or indirectly related to a parameter selected from the group of: a maximum value of the connection-specific transmitter power, a power change step size, and a quality target parameter.

33. The control unit of claim 27, wherein the determining step is further based on a current total transmitter power of the transceiver node (122).

34. A communication system (100) provided with means for power control and including a transceiver node (122) capable of communicating with multiple mobile terminals (110), comprising
means for receiving, at the transceiver node, a transmitter power change request from one of the mobile terminals over a wireless connection;
means for determining a power control parameter for the connection based on connection-specific information indicating the degree of priority associated with the connection; and
means for distributing transmitter power to the connection in accordance with the power control parameter.

35. The communication system of claim 34, further comprising
means for automatically classifying the mobile terminal (110) at the network side based on connection-related information; and
means for using the mobile class from the classifying step in the determining step.

36. The communication system of claim 34, comprising means for determining the power control parameter based also on a current total transmitter power of the transceiver node (122).

37. The communication system of claim 34, being selected from the group of: a Code Division Multiple Access (CDMA) system, a Wideband Code Division Multiple Access (WCDMA) system, an Orthogonal Frequency Division Multiplexing (OFDM) system, and a system using Multi Carrier Power Amplifiers (MCPA).
